(19) United States
(12) Patent Application Publication
(10) Pub. No.: US 2015/0205395 A1
(43) Pub. Date: Jul. 23, 2015

(54) ELECTRONIC DEVICE

(71) Applicant: HON HIA PRECISION INDUSTRY CO., LTD., New Taipei (TW)

(72) Inventors: TAY-YANG LIN, New Taipei (TW); CHIN-FENG CHEN, New Taipei (TW); CHIA-JUNG LIU, New Taipei (TW); SHU-MING LIU, New Taipei (TW)

(73) Assignee: HON HAI PRECISION INDUSTRY CO., LTD., New Taipei (TW)

(21) Appl. No.: 14/159,675

(22) Filed: Jan. 21, 2014

(51) Int. Cl. G06F 3/041; G06F 3/0354; G06F 3/02

(52) U.S. Cl. CPC G06F 3/041; G06F 3/02; G06F 3/03547

(57) ABSTRACT

An electronic device includes a base member and a display member rotatably coupled to the base member. A keyboard and a touchpad are located on a working surface of the base member. The touchpad includes a middle touch area, a left touch area, and a right touch area. When the touchpad works in a full touch mode, the middle touch area, the left touch area, and the right touch area are all enabled to sense and recognize touch gestures input by a user of the electronic device. When the touchpad works in a partial touch mode, at least one of the middle touch area, the left touch area, and the right touch area is disabled from sensing and recognizing touch gestures.

### REFERENCE TO RELATED APPLICATIONS

This application claims all benefits accruing under 35 U.S.C. §119 from Taiwan Patent Application No. 102103394, filed on Jan. 30, 2013 in the Taiwan Intellectual Property Office. The contents of the Taiwan Application are hereby incorporated by reference. In addition, subject matter relevant to this application is disclosed in: co-pending U.S. Patent Application entitled “ELECTRONIC DEVICE AND HUMAN-COMPUTER INTERACTION METHOD,” Attorney Docket Number US51062, application Ser. No. [to be advised], filed on the same day as the present application. This application and the co-pending U.S. Patent Application are commonly owned, and the contents of the co-pending U.S. Patent Applications are hereby incorporated by reference.

### BACKGROUND

1. Technical Field

The disclosure generally relates to electronic devices, and particularly relates to electronic devices having a touchpad.

2. Description of Related Art

Many notebook computers use touchpads as a “cursor navigator” as well as a component for selecting functions such as “select” and “confirm.” However, the touchpads are often small and incapable of recognizing more complex touch operations.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an exemplary embodiment of an electronic device.

FIG. 2 is a schematic view of a base member of the electronic device of FIG. 1.

FIG. 3 is a schematic view of the base member working in a full touch mode.

FIG. 4 is a schematic view of the base member working in a partial touch mode.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

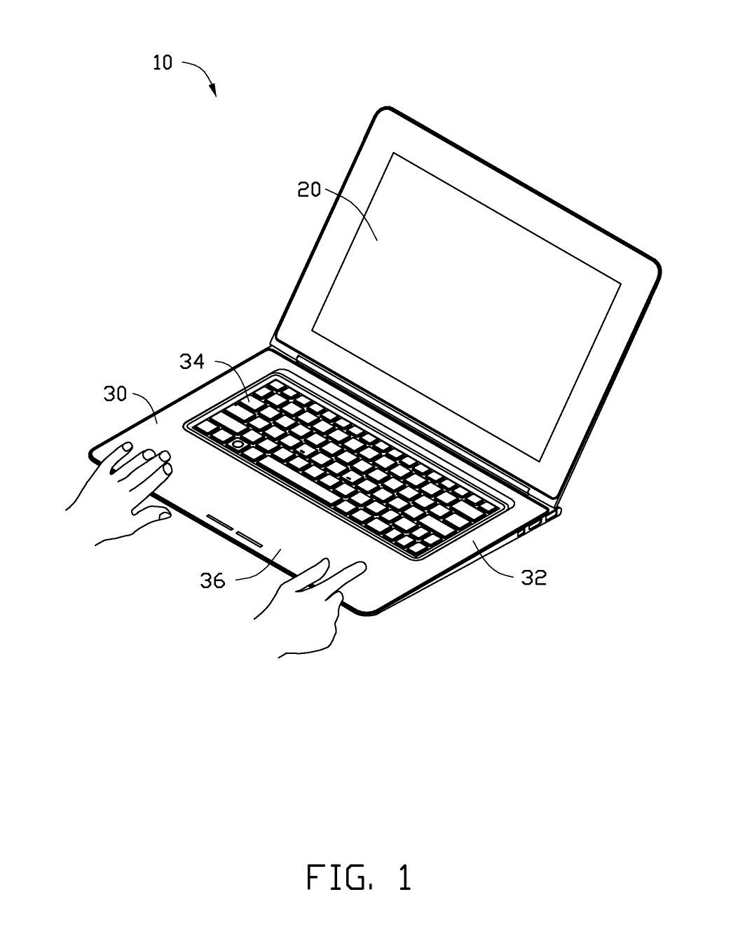

FIG. 1 is a block diagram of an embodiment of an electronic device 10. The electronic device 10 can be, but is not limited to, a notebook computer, a tablet computer, a gaming device, a DVD player, a radio, a television, a personal digital assistant (PDA), a smart phone, or any other type of portable or non-portable electronic device.

In one embodiment, the electronic device 10 includes a display member 20 rotatably coupled to a base member 30 to enable variable positioning of the display member 10 relative to the base member 30. A keyboard 34 and a touchpad 36 are located on a working surface 32 of the base member 30. In the illustrated embodiment, the touchpad 36 is located in front of the keyboard 34.

In one embodiment, a length of the touchpad 36 is greater than 18 centimeters (cm), so that the touchpad 36 is suitable for two-hand operation by a user of the electronic device 10. The length of the touchpad 36 is substantially the same as the length of the keyboard 34. In other embodiments, the length of the touchpad 36 is substantially the same as the length of the base member 30.

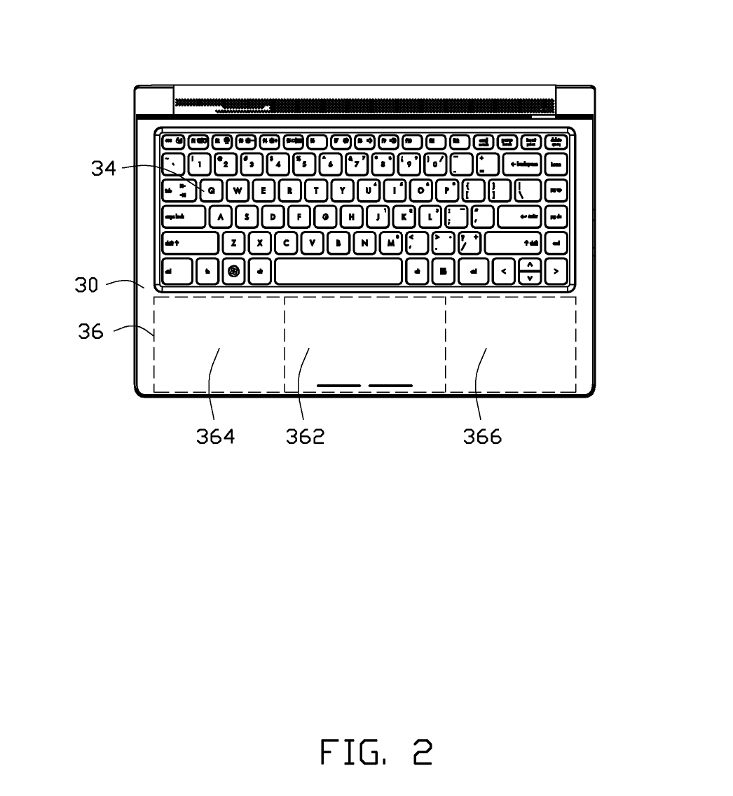

Referring to FIG. 2, the touchpad 36 includes a middle touch area 362, a left touch area 364, and a right touch area 366. The left touch area 364 is located on a left side of the middle touch area 362, and the right touch area 366 is located on a right side of the middle touch area 362. In one embodiment, the left touch area 364 and the right touch area 366 are seamlessly connected to the middle touch area 362.

In one embodiment, the touchpad 36 can work in a full touch mode or a partial touch mode. When the touchpad 36 works in the full touch mode, the middle touch area 362, the left touch area 364, and the right touch area 366 are all enabled to sense and recognize touch gestures input by the user of the electronic device 10. When the touchpad 36 works in the partial touch mode, at least one, but not all of the middle touch area 362, the left touch area 364, and the right touch area 366 is disabled from sensing and recognizing any touch gestures input by the user of the electronic device 10.

For example, when the left touch area 364 is disabled, and the middle touch area 362 and the right touch area 366 remain enabled, the left touch area 364 cannot sense or recognize any touch gestures input by the user, but the middle touch area 362 and the right touch area 366 can still sense and recognize the touch gestures input by the user.

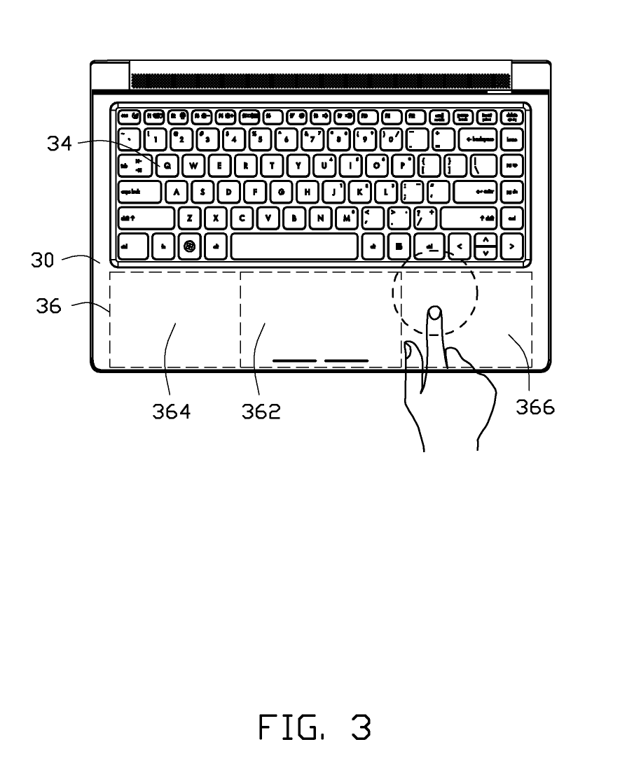

For example, in an initial state, when the electronic device 10 is booted up, the touchpad 36 works in the full touch mode. As shown in FIG. 3, the middle touch area 362, the left touch area 364, and the right touch area 366 are all enabled. Thus, the user can touch any location of the touchpad 36 to input effective touch gestures.

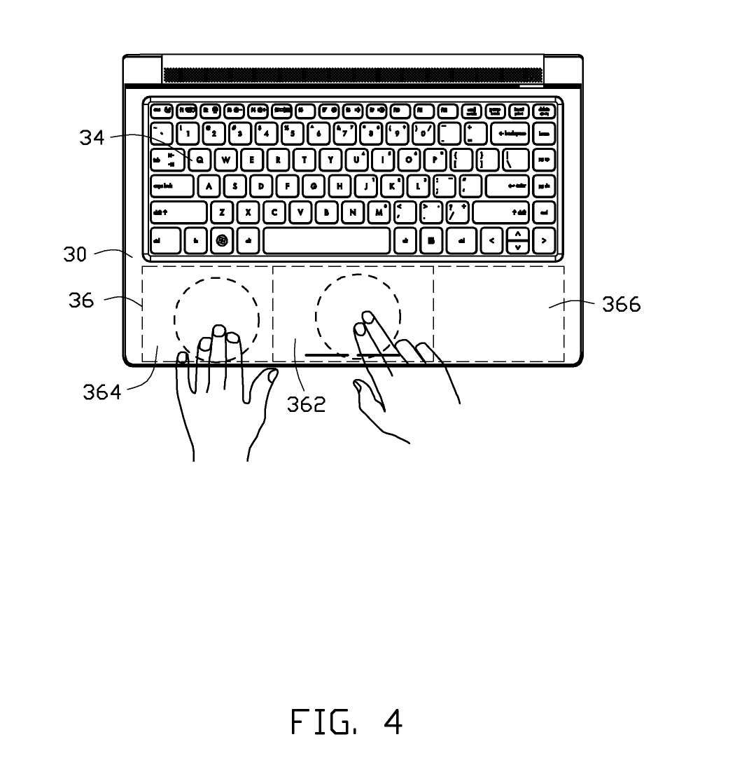

As illustrated in FIG. 4, when two touch areas, such as the middle touch area 362 and the left touch area 364, simultaneously detect a touch gesture, the touchpad 36 disables the right touch area 366, so that the touchpad 36 is switched to the partial touch mode, and only the middle touch area 362 and the left touch area 364 can continue sensing and recognizing the touch gestures input by the user. In one embodiment, when the touchpad 36 works in the partial touch mode, the middle touch area 362 is selected to simulate a pointing device such as a mouse, and the left touch area 364 is selected to sense and recognize other touch gestures.

When two touch areas for example, the middle touch area 362 and the left touch area 364, detect no touch gesture, the touchpad 36 is switched to the full touch mode, so that the middle touch area 362, the left touch area 364, and the right touch area 366 are all enabled to sense and recognize the touch gestures input by the user.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

What is claimed is:

1. An electronic device, comprising:
a base member;
a display member rotatably coupled to the base member; and
a keyboard and a touchpad located on a working surface of the base member; the touchpad comprising a middle touch area, a left touch area, and a right touch area; the left touch area and the right touch area being located on two sides of the middle touch area;
wherein the touchpad is configured for selectively working in a full touch mode and a partial touch mode; when the touchpad works in the full touch mode, the middle touch area, the left touch area, and the right touch area are all enabled to sense and recognize touch gestures input by a user of the electronic device; when the touchpad works in the partial touch mode, at least one of the middle touch area, the left touch area, and the right touch area is disabled from sensing and recognizing touch gestures input by the user of the electronic device.

2. The electronic device of claim 1, wherein the left touch area and the right touch area are seamlessly connected to the middle touch area.

3. The electronic device of claim 2, wherein when the touchpad works in the partial touch mode, one of the middle touch area, the left touch area, and the right touch area is selected to simulate a pointing device.

4. The electronic device of claim 2, wherein when two touch areas of the middle touch area, the left touch area, and the right touch area, simultaneously detect a touch gesture, the touchpad switched to the partial touch mode.

5. The electronic device of claim 2, wherein when two touch areas of the middle touch area, the left touch area, and the right touch area, detect no touch gesture, the touchpad is switched to the full touch mode.

6. The electronic device of claim 2, wherein the touchpad is suitable for two-hand operation of the user of the electronic device.

7. The electronic device of claim 2, wherein a length of the touchpad is substantially the same as a length of the keyboard.

8. The electronic device of claim 2, wherein a length of the touchpad is substantially the same as a length of the base member.

9. An electronic device, comprising:
a base member;
a display member rotatably coupled to the base member; and
a keyboard and a touchpad located on a working surface of the base member; the touchpad comprising a first touch area, a second touch area, and a third touch area;
wherein when the first touch area and the second touch area simultaneously detect a touch gesture, the touchpad is configured for disabling the third touch area to sense or recognize any touch gesture.

10. The electronic device of claim 9, wherein one of the first touch area and the second touch area is selected to simulate a pointing device.

11. The electronic device of claim 9, wherein the first touch area and the third touch area are located on two sides of the second touch area and are seamlessly connected to the second touch area; the touchpad is suitable for two-hand operation of the user of the electronic device.

12. The electronic device of claim 9, wherein a length of the touchpad is substantially the same as a length of the keyboard.

13. The electronic device of claim 9, wherein a length of the touchpad is substantially the same as a length of the base member.

14. An electronic device, comprising:
a base member;
a display member rotatably coupled to the base member; and
a keyboard and a touchpad located on a working surface of the base member, wherein the touchpad is located in front of the keyboard and is suitable for two-hand operation by a user of the electronic device.

15. The electronic device of claim 14, wherein a length of the touchpad is substantially the same as a length of the keyboard.

16. The electronic device of claim 14, wherein a length of the touchpad is substantially the same as a length of the base member.

17. The electronic device of claim 14, wherein the touchpad comprises a middle touch area, a left touch area, and a right touch area; the left touch area and the right touch area are located on two sides of the middle touch area and are seamlessly connected to the middle touch area; the touchpad is configured for selectively working in a full touch mode and a partial touch mode; when the touchpad works in the full touch mode, the middle touch area, the left touch area, and the right touch area are all enabled to sense and recognize touch gestures input by the user of the electronic device; when the touchpad works in the partial touch mode, at least one of the middle touch area, the left touch area, and the right touch area is disabled from sensing and recognizing touch gestures input by the user of the electronic device.

18. The electronic device of claim 17, wherein when the touchpad works in the partial touch mode, one of the middle touch area, the left touch area, and the right touch area is selected to simulate a pointing device.

19. The electronic device of claim 17, wherein when two touch areas of the middle touch area, the left touch area, and the right touch area, simultaneously detect a touch gesture, the touchpad is switched to the partial touch mode.

20. The electronic device of claim 17, wherein when two touch areas of the middle touch area, the left touch area, and the right touch area, detect no touch gesture, the touchpad is switched to the full touch mode.
